(19) United States
(12) Patent Application Publication
(10) Pub. No.: US 2016/0380904 A1
(43) Pub. Date: Dec. 29, 2016

(54) INSTRUCTION SELECTION BASED ON A GENERIC DIRECTIVE

(71) Applicant: Trifectix, Inc., Cedar Park, TX (US)

(72) Inventors: Robin Fuller, Round Rock, TX (US); Joe Senner, Georgetown, TX (US); Timothy Wall, Georgetown, TX (US); Kristy McDougal, Austin, TX (US)

(73) Assignee: Trifectix, Inc., Cedar Park, TX (US)

(21) Appl. No.: 14/750,612

(22) Filed: Jun. 25, 2015

(51) Int. Cl. H04L 12/911

(52) U.S. Cl. CPC H04L 47/70

(57) ABSTRACT

Systems and methods are provided for instruction selection based on a generic directive. In some embodiments, a system may receive a request to perform a generic task or directive. The system may determine a networked computing node to perform the task, and may access a configurations database to determine configuration information and parameters of the computing node. The system may also access an instructions database to determine one or more instruction sets that may be used to perform the task based on the configurations and parameters of the computing node. If the instructions database includes a compatible instruction set for performing the specified task on the configuration of the computing node, the instruction set may be retrieved and provided in response to the received request.

### BACKGROUND

Systems or “nodes” in a network may be configured in different ways. Various nodes may run different operating systems, may run different applications, may have different available features, or any combination thereof. When a user, such as an administrator, desires to perform a task that can impact a node through a network, the user may not know how to implement the task on that specific node, such as which instructions or commands to use, without a priori knowledge of how the node is configured.

### SUMMARY

In some embodiments, a memory device may include instructions that, when executed, cause a processor to receive a request to perform a designated task, determine a computing node to perform the designated task, determine a specific instruction set to perform the designated task based on one or more characteristics associated with the computing node, and provide the specific instruction set to the computing node in response to the request.

In another embodiment, a method may include receiving a request to perform a designated task, determining a selected application configured to perform the designated task, determining a computing node having an instance of the selected application, determining a specific instruction set to perform the designated task on the selected application, and providing the specific instruction set to computing node in response to the request.

In yet another embodiment, a system may include a processor configured to receive a request to perform a designated task, determine a computing node to perform the designated task, determine a specific instruction set to perform the designated task based on the computing node, and provide the specific instruction set in response to the request.

### BRIEF DESCRIPTION OF THE DRAWINGS

FIG. 1 is a block diagram of a system configured to select instructions based on a generic directive, in accordance with certain embodiments of the present disclosure;

FIG. 2 is a block diagram of a system configured to select instructions based on a generic directive, in accordance with certain embodiments of the present disclosure;

FIG. 3 is a diagram of data elements used by a system configured to select instructions based on a generic directive, in accordance with certain embodiments of the present disclosure; and

FIG. 4 is a flowchart of a method of instruction selection based on a generic directive, in accordance with certain embodiments of the present disclosure.

### DETAILED DESCRIPTION

In the following detailed description of the embodiments, reference is made to the accompanying drawings which form a part hereof, and in which are shown by way of illustrations. It is to be understood that features of the various described embodiments may be combined, other embodiments may be utilized, and structural changes may be made without departing from the scope of the present disclosure. It is also to be understood that features of the various embodiments and examples herein can be combined, exchanged, or removed without departing from the scope of the present disclosure.

In accordance with various embodiments, the methods and functions described herein may be implemented as one or more software programs executed by a computer processor or controller circuit. In accordance with various embodiments, the methods and functions described herein may be implemented as one or more software programs executed by a computing device, such as a tablet computer, a smart phone, a personal computer, a server, or any other computing device. Dedicated hardware implementations including, but not limited to, application specific integrated circuits, programmable logic arrays, and other hardware devices can likewise be constructed to implement the methods and functions described herein. Further, the methods described herein may be implemented as a device, such as a nonvolatile computer readable storage medium, a data storage device, or memory device, including instructions that, when executed, cause a processor to perform the methods.

Various services and operations may be provided or performed using computing devices networked together. “Nodes” may refer to electronic devices (such as computing devices, switches, routers, firewalls, and other devices) coupled to a network, or may refer to services, firmware, or software applications running on one or more electronic devices coupled to a network. For example, multiple computing devices (such as servers, workstations, or other systems) may operate within a network and be referred to as “nodes.” In some embodiments, “node” may also refer to a software application or service executing on a single device. In some embodiments, a node may also include firmware or software, such as middleware or enterprise applications, executing across multiple devices. For example, middleware may include software that provides services and functionality for use by other software applications, such as by operation between the operating system and user-level applications. Middleware can communicatively couple software components and enterprise applications, and can include web servers, application servers, content management systems, and similar tools that support application development and delivery. Enterprise applications may include large or complex software platforms deployed across devices on a network. The nodes on a network may be used to operate websites, to provide cloud-based streamed content or services, to maintain databases, to provide other services or content, to perform data processing or perform other operations, or any combination thereof.

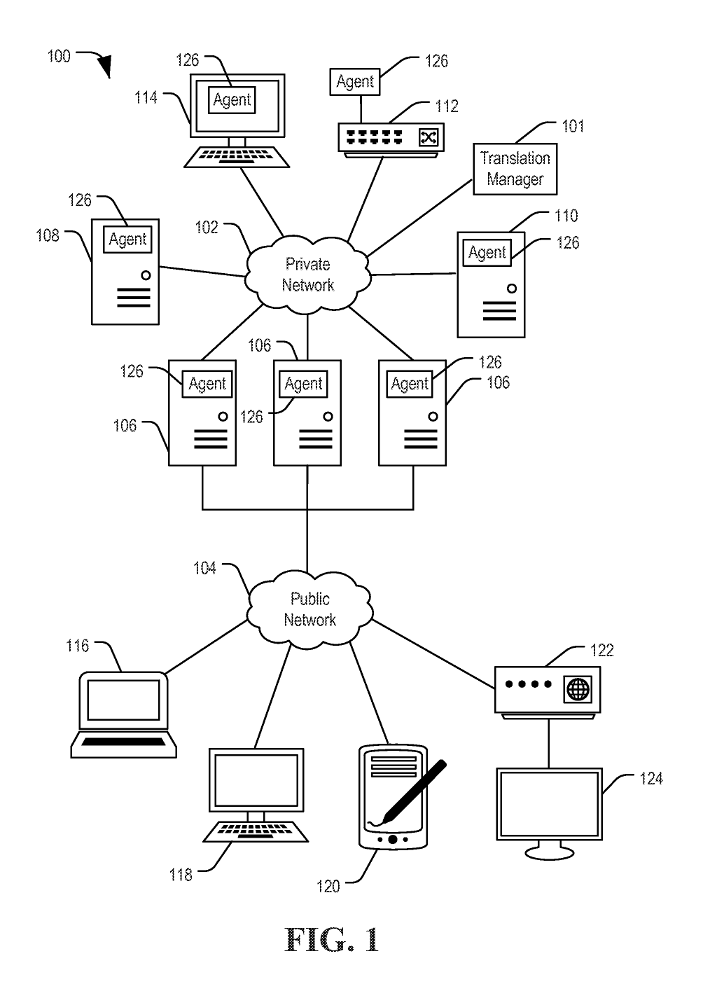

Nodes coupled to a network may be configured or structured in different ways, including running different operating systems, running different firmware, executing different applications, offering different features, or any combination thereof. Different nodes within a network may be capable of performing the same tasks or operations, but may use different programs or applications to implement those operations. For example, different nodes may be running completely different applications or operating systems, may be running different versions of the same applications or operating systems, or may have different system architectures. Accordingly, the different nodes may require different instructions in order to initiate or perform the same general tasks. Because networks may include a large number of nodes having a large number of different configurations and capabilities (e.g., which may require different instruction sets), performing particular tasks for such networks can be time consuming, complex, and inefficient. An example embodiment of a network having multiple nodes with different configuration is shown in regards to FIG. 1.

FIG. 1 depicts a block diagram of a system 100 configured to select instructions based on a generic directive, in accordance with certain embodiments of the present disclosure. As used herein, the term “generic task” or “generic directive” refers to an instruction, task, or directive that specifies an action to be performed. In some embodiments, a generic task or directive may also designate a specific device or node, or a type of device or node, associated with a network but without concern for the specific configuration of the device or node. For example, a generic task may instruct a node to create a file within a directory, without specifying how such a task should be performed at the particular node. In another example, the generic task may include an instruction to update a server application to an upgraded version without specifying specific instructions for performing such upgrades with respect to any particular operating system.

System 100 may be an example of a service provider or other business having multiple computing devices or nodes coupled to the service provider's private network 102. One or more edge servers 106 may selectively communicate data from the private network 102 to one or more devices coupled to a public network 104, or edge servers 106 may receive data directed to one or more devices coupled to private network 102 from devices coupled to public network 104.

For example, the service provider may offer access to content or services, such as access to movies, music, or computer programs, access to voice or video communication channels, access to other content or services, or any combination thereof. Computing devices coupled to a public network 104, such as the Internet, may be used to access the content. In some embodiments, the private network 102 may be maintained by a large company, such as a media content distribution company such as a cable or Internet Protocol (IP) television provider. Other embodiments are also possible.

In some embodiments, multiple nodes may be coupled to private network 102. The various nodes may include different types of devices, and may have different combinations of physical architectures, operating systems, computer software, drivers, or other variable parameters. In some embodiments, the various nodes may include applications running on one or more devices coupled to private network 102. In some embodiments, the nodes on private network 102 may be geographically separated. For example, private network 102 may have elements coupled thereto at multiple locations in order to service users in different geographical regions with minimal latency. The nodes may be set up at different times and by different teams, and may include different components, and may run different software or software versions. Accordingly, it may be difficult or inefficient for users or administrators of private network 102 to manage the various nodes.

In some embodiments, one or more “edge servers” 106 may be coupled to private network 102. Edge servers 106 may be located at the “edge” between private network 102 and public network 104, and may provide security or firewall functionality, routing and load balancing, other functionality, or any combination thereof. The edge servers 106 may handle data received from and transmitted to public network 104.

In some embodiments, one or more content servers 108 may also be coupled to private network 102. For example, a content server 108 may store and manage databases of information, audio or video content for streaming or distribution, or other information, or any combination thereof. In some embodiments, one or more transactional servers 110 may be coupled to private network 102. A transactional server 110 may handle data requests, user authentication, back-end payment processing, other functionality, or any combination thereof. In some embodiments, routing manager 112 may be coupled to private network 102. Routing manager 112 may provide functionality such as load balancing, network mapping, packet routing, other functionality, or any combination thereof. One or more administrative terminals 114 may be coupled to private network 102. Administrative terminal 114 may be accessed by users to communicate with other terminals over private network 102, to access public network 104, to access data or resources from nodes on private network 102, to perform other functions, or any combination thereof. In some embodiments, administrative terminals 114 may be used to manage settings, configurations, software or firmware upgrades or installation, or other parameters of nodes on private network 102. A user of administrative terminal 114 may submit requests to perform a generic task or directive at a node of private network 102, according to embodiments of the present disclosure.

As discussed above, each of the nodes coupled to private network 102 may represent one or more computing devices, one or more software applications, or any combination thereof. For example, content server 108 may include a web server middleware node executed by a plurality of server computing devices. Other embodiments are also possible.

A variety of devices, systems, and networks may be coupled to public network 104. For example, a variety of user devices may be coupled to public network 104 directly or indirectly (e.g., through a network router or modem). User devices may include laptop computers 116, desktop computers or workstations 118, tablets or smart phones 120, set-top box devices 122 (e.g., internet-ready gaming consoles or media streaming devices), monitors such as “smart” televisions 124, other devices, or any combination thereof. In some embodiments, televisions 124 or other devices may be coupled to the public network 104 only through a set-top box device 122 or similar device. In some embodiments, one or more of the user devices may be used to access content by connecting to private network 102 via public network 104.

In some embodiments, system 100 may include a translation manager 101 coupled to private network 102 and configured to receive a request to perform a generic task on a specified node of the private network 102. In response to the request, the translation manager 101 may determine configuration information and parameters associated with the specified node. The translation manager 101 may determine a set of instructions which may be used to perform the task on the specified node, based on the configuration information and parameters of the specified node. Requests to perform tasks may originate from within a network (e.g. at terminal 114 on private network 102 to perform a task at a node of private network 102, such as to update a database), or from outside the network (e.g. from user device 118 on public network 104 to perform a task on a node of private network 102, such as to create a hosted website). In some embodiments, a user at terminal 114 may specify a generic task to perform software updates on set-top box devices 122. Even though the set-top box devices 122 are “outside” private network 102, they may be considered part of a single managed network, along with private network 102, for the purposes of receiving instructions based on generic tasks.

In some embodiments, the translation manager 101 may select specific instructions based on a generic directive or task and may communicate the selected instructions to one or more nodes on private network 102. In some embodiments, at least some of the nodes on private network 102 may be configured with an agent application 126. The agent application 126 may be a plugin, driver, or macro instruction set that runs within another application, such as a server application or network browser application, or may be an application or service that executes in the background on a computing device. In some embodiments, the agent application 126 may receive instructions from the translation manager 101 and may respond to the instructions. The agent application 126 may receive a request to provide information about the node on which it is executing, may determine configuration and characteristics of the node, and may communicate the configuration and characteristics to the translation manager 101, which may store the data in a database and which may use the data to determine the specific set of instructions suitable for execution at a selected node. The agent application 126 may receive the instructions from the translation manager 101 and may perform a task based on the instructions. For example, the agent application 126 may execute the specific instructions received from the translation manager 101 for performing a user-selected generic task.

In some embodiments, a user may submit a request using terminal 114 to perform a task on a selected node of private network 102. The translation manager 101 may determine a configuration of the selected node and may retrieve a corresponding set of specific instructions to provide to the selected node. In some embodiments, as mentioned above, the translation manager 101 may send the selected instructions to the agent application 126 of a selected node, and the agent application 126 may execute the instructions to implement changes at the node.

While the translation manager 101 is depicted as a stand-alone device, in some embodiments, the translation manager 101 may be implemented as a software application that may be executed at one or more of the nodes, or as a circuit or other physical component of one or more of the nodes. In some embodiments, instead of the agent application 126, each node may include a translation manager 101, which may be configured to access a database to retrieve instructions suitable for execution at the node in response to the request. In some embodiments, one or more nodes may include both an agent application 126 and a translation manager 101. In some embodiments, one or more nodes may include a module that is configured to execute the functionality of both the translation manager 101 and agent application 126 as described herein.

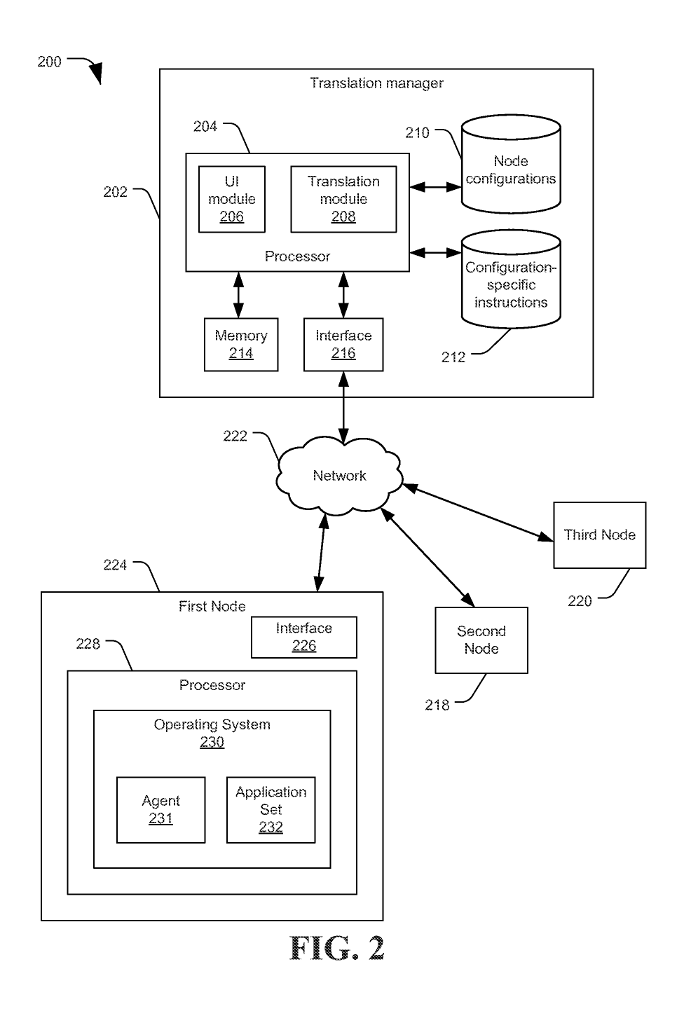

According to embodiments of the present disclosure, a translation manager 101 may be configured to store, retrieve, or both retrieve and store information regarding how to perform different tasks with respect to different operating systems, different applications, different application versions, other node-specific configurations, or any combination thereof. The translation manager 101 may also store, retrieve, or both retrieve and store information regarding the specific configurations of nodes within the network. The translation manager 101 may be configured to receive a generic directive or a request for a generic task to be performed, and may determine the configuration of a node and the appropriate instructions to execute the generic task on the identified node in response to receiving the directive or request. Accordingly, the translation manager 101 may allow a user having little or no specific knowledge of the configurations of nodes on a network to perform a variety of tasks using those nodes. Example embodiments of a translation manger 101 are described below in relation to FIG. 2.

FIG. 2 is a block diagram of a system 200 configured to select instructions based on a generic directive, in accordance with certain embodiments of the present disclosure. System 200 may include a translation manager 202, which may operate on or include one or more computing devices. In some embodiments, the translation manager 202 may be an implementation of the translation manager 101 of FIG. 1. For example, translation manager 202 may include a desktop computer or workstation having one or more interfaces to receive user input and a display to provide information to a user. In another embodiment, translation manager 202 may be a server that may receive input associated with a user and provide data to a device associated with a user at a computing device through a network 222. In some embodiments, translation manager 202 may include one or more circuits within a computing device. In some embodiments, translation manager 202 may include software or other computer instructions executable by one or more computing devices. Other embodiments are also possible.

In an example embodiment, the translation manager 202 may include one or more processors 204, memories 214, interfaces 216, and databases 210 and 212. A database may be an organized collection of data stored in one or more data storage devices. The data may be stored locally in a memory of translation manager 202, such as to memory 214 or another memory, or may be stored remotely at another storage device accessible to translation manager 202.

In an example embodiment, translation manager 202 may include a node configuration database 210, which may include information regarding nodes within a network, such as node identifiers, node configuration information, node operating systems, available node applications or node functions, other information, or any combination thereof. The node configuration information may be entered by one or more users, or via other methods. For example, the translation manager 202 may query nodes on the network 222 to obtain configuration information from the nodes. As discussed above, an agent application 231 on each node may provide configuration data to the translation manager 202 in response to the query. In some embodiments, the agent application 231 may be an implementation of the agent application 126 of FIG. 1, and may provide data to translation manager 202 or execute instructions received from translation manager 202. The node configuration database 210 may be updated manually, or may update automatically when configuration changes or updates are received that are associated with nodes on the network 222. Configuration data may also be obtained by other methods, or a combination of methods.

Translation manager 202 may include an instructions database 212 including configuration-specific instructions that may be suitable for particular configurations of a node, including the node's operating system, applications, drivers, or any combination thereof. Instructions database 212 may include instruction names, tasks, directives, or any combination thereof. The directives may provide specific mechanics of how to perform each instruction or task on a specific type of system. For example, instructions database 212 may store computer instructions, operation steps, or other information regarding how to perform a designated task on different types of operating systems or on different application software. In some embodiments, the instructions database 212 may store instructions, operation steps, or other information regarding how to perform the task based on other configuration information regarding a node, based on other information, or any combination thereof. Further, in addition to instructions or steps about how to perform the task, the instructions database 212 may include the specific instructions that, when executed, cause the agent application 231 or the processing circuitry 228 of the node to perform the task.

In some embodiments, instructions database 212 may also include supplementary information about specific instruction sets or tasks. For example, the instructions database may also include information related to the duration or resource needs of particular instruction sets or tasks. For example, the database 212 may include an estimate on how long a selected task will take to execute on a particular node configuration. The supplementary information may be retrieved and provided to a user via the UI module 206, to assist the user for planning or logistical purposes. For example, the translation manager may receive a task selection, and may retrieve and provide supplementary information on the selected task to a user prior to executing the task. The user may determine whether to proceed with the task based on the supplementary information. In some embodiments, supplementary information for multiple potential instruction sets may be provided, and a user may elect one of the potential instruction sets based on the supplementary information.

In some embodiments, the translation manager 202 may obtain the supplementary information based in whole or in part on monitoring task execution results. For example, the translation manager 202 may monitor and record the duration of performing various configuration-specific tasks or instruction sets, and may store the duration to the instructions database 212. The execution duration of the task may be measured by an agent module 231 of a node or by other means, and provided to the translation manager 202 for recording. The previously-monitored durations may be used to estimate future executions. For example, the translation manager 202 may generate time or resource averages, confidence information, or other information based on multiple iterations. In some embodiments, the time or resource estimates may be manually entered, computed and stored by translation manager 202 using processor 204, or otherwise determined.

Memory 214 may include one or more volatile or non-volatile data storage devices or mediums, or any combination thereof. In some embodiments, memory 214 may store computer-readable instructions that, when executed, may cause the processor 204 to perform the methods and operations described herein. Memory 214 may also include nonvolatile storage for data maintained at or accessible by translation manager 202, volatile memory used as a cache for the processor 204, other memory, or any combination thereof.

Interface 216 may include one or more wired or wireless communication interfaces configured to communicate data from or receive data at the translation manager 202, allowing for communication with other devices through one or more networks or communication links. For example, interface 216 may include an Ethernet port, a universal serial bus (USB) port, a wireless transceiver, another interface, or any combination thereof. In some embodiments, interface 216 may be configured to couple to one or more input-output (I/O) devices, such as via a USB cable, to receive or transmit data. Interface 216 may be used to couple to other computing devices, either directly or via a network, such as network 222. For example, network 222 may include a local area network (LAN), a wide-area network (WAN), another network, or any combination thereof. In some embodiments, network 222 may be a local network that communicatively couples the translation manager 202 to a first node 224, a second node 218, and a third node 220.

Processor 204 of translation manager 202 may include one or more central processing units (CPUs), field programmable gate arrays (FPGAs), application-specific integrated circuits (ASICs), other circuits, or any combination thereof. The processor 204 may include hardware modules, software modules, or a combination thereof, configured to perform the operations of the translation manager 202. A “module” may be one or more physical components of a computing device (e.g., circuits) configured to perform a particular task or job, or it may be a program that, when executed, causes a processor to perform the particular task or job. The processor 204 may perform logical operations, access data, modify or manipulate data, and perform data storage operations. In some embodiments, the processor 204 may include a user interface (UI) module 206 and a translation module 208.

The UI module 206 may be configured to receive inputs from, and provide data to, a user device or other node. The UI module 206 may allow the user or node to interact with the translation manager 202. For example, the UI module 206 may receive inputs from input devices, such as keyboards and mice, and may display data via a monitor or other display screen. In some embodiments, the UI module 206 may generate a graphical user interface (GUI), which may include one or more user-selectable elements with which a user may interact to designate a generic task or directive for execution by a node on the network 222. A GUI may also provide a user or device with information, such as information regarding the results of a requested task or directive, or a prompt for additional information. In some embodiments, the GUI may be presented in the form of a web page, an interface of a computer application, or another interface that may be presented to a display of a computing device and by which a user or application may send data to or receive data from the translation manager 202. In some embodiments, the GUI may be sent to the computing device, and the GUI may be rendered by the processor of the computing device to display the information, the user-selectable elements, or both. In an example, a user may interact with user-selectable elements to specify a directive for execution and to submit the directive to the translation manager 202.

The translation module 208 may be configured to receive an indication of a designated generic task or directive, and may determine specific instructions which may be used to implement the task. In some embodiments, the translation module 208 may automatically determine one or more target systems or nodes based on the generic task or directive and may determine the respective configurations of the one or more target systems or nodes. The translation module 208 may automatically select execution instructions for the particular configurations of a target system or node based on the generic task or directive. For example, after receiving a generic task or directive the translation module 208 may determine a target node for the task. Based on the configuration of the target node, the translation module 208 may look up the configuration-specific instructions for the target node that will implement the task on that node. The translation module 208 may further provide the configuration-specific instructions to the target node, to a user or system that submitted the generic task, to an agent application 231, or any combination thereof. In some embodiments, the translation module 208 may store the instructions to a memory, or may otherwise utilize the instructions.

In some embodiments, the translation module 208 may be configured to receive input data, such as an indication of a designated generic task or directive. For example, a generic task or directive may include commands or instructions such as “create a website,” “update applications,” “create a database,” “set designated parameter to X value”, other tasks, or any combination thereof. In some embodiments, the input data may also designate a node or nodes on which the directive is to be executed. In some embodiments, the node or nodes on which to execute the directive may be selected by translation manager 202 from among nodes capable of performing the directive, or may be selected by the translation manager 202 from among nodes of a particular type or from nodes that perform a particular function. The input data may be based on information provided by a user, may be generated by the translation manager 202, may be generated by another node coupled to network 222, may originate from another source, or any combination thereof. The translation module 208 may access the node configurations database 210 to determine the configuration settings of the designated node(s), or to select one or more nodes to execute the generic task. After determining the configuration of the designated node(s), the translation module 208 may then access the instructions database 212 to determine a set of instructions or steps to execute the generic directive based on the configuration of the designated node(s). The instructions or steps may be provided to a user, stored to a memory (such as memory 214), transmitted to the designated node for execution, or any combination thereof. In some embodiments, the node may include an agent application 231 configured to receive the instructions or steps and to perform the task based on the received instructions or steps.

In some embodiments, the designated node may be capable of performing the designated task or directive in more than one way, such as by using one of two or more locally stored applications. In such embodiments, the translation module 208 may request an additional selection from the user to specify a preferred method of executing the task. In some embodiments, the translation module 208 may select a default option from the multiple options. Other embodiments are also possible.

In some embodiments, the input data may designate a generic task or directive, without designating a specific node for execution. The translation module 208 may access the node configurations database 210 to determine a node capable of performing the task. In some embodiments, the translation module 208 may determine a node that may be able to perform the task fastest, most efficiently, or according to some other metric (e.g., which node has superior processing power, has applications better suited to the task than other nodes, is idle or has a low workload, would be suitable based on other factors, or any combination thereof). Based on the determined node, the translation module 208 may then determine the instructions or steps for executing the task using the selected node, and in some embodiments may send the instructions or steps to the node. In some embodiments, the translation module 208 may be located at the selected node and may execute the determined instructions or steps. Other embodiments are also possible.

In some embodiments, the input data may designate a task to perform on a plurality of target nodes of network 222, on a designated subset of target nodes, or any combination of nodes. For example, a user may designate a task for all nodes running Microsoft Windows® operating systems to upgrade to a particular version of the Microsoft Windows® operating system. The translation module 208 may determine one or more nodes to be upgraded, e.g. based on the node configurations database 210. Nodes running different versions of the operating system may utilize different instruction sets to complete the upgrade operation, and accordingly the translation module 208 may determine a plurality of instructions corresponding to the different operating system versions, including, for example, an incremental upgrade process involving installation of service packs, patches, and other incremental upgrades needed to complete the task. In another example embodiment, the generic task may include searching for updates for the operating systems of all nodes on network 222. The translation module 208 may determine the instructions to direct each node to search for updates. In another embodiment, the translation module 208 may determine the operating systems of the nodes using information in the node configurations database 210, search for updates for those operating systems, and push the updates to any nodes for which an update is available. Other implementations are also possible.

In some embodiments, instructions database 212 may include instructions for execution by the translation module 208, instead of or in addition to instructions to be executed on target nodes. For example, translation module 208 may receive a generic task to update the operating system on one or more nodes. The translation module 208 may determine the configurations and operating systems of the target nodes using node configurations database 210. The translation module 208 may then retrieve instructions regarding how to update the operating system for nodes having the particular configurations from the instructions database 212. The instructions may direct the translation module 208 to search the Internet for updates for the target operating systems, and to provide the target nodes with the downloaded updates and instructions for installing the updates. In some embodiments, the translation module 208 may provide the downloaded updates to the particular nodes in a sequence.

In another example embodiment, the translation module 208 may be directed to upgrade the operating systems associated with a number of nodes. The instructions for updating the nodes may include instructions directing the translation module 208 to determine a number of available licenses for performing the upgrade, and if necessary, to notify a user of a number of licenses still needed to upgrade the designated nodes. The translation module 208 may also be directed to determine, based on data from the node configurations database 210, applications executed by or running on the target nodes, which applications may not be compatible with the upgraded operating systems. For example, part of the process for upgrading the operating systems may require the translation module 208 to determine and upgrade other applications of the target nodes to maintain compatibility between the operating system and the hosted applications. Other embodiments are also possible.

The first node 224 may be coupled to the network 222 and may be used to execute generic tasks or directives based on specific instructions selected by translation module 208. In some embodiments, first node 224 may include an interface 226 and a processor 228. The interface 226 may be a wired or wireless communication interface, which may be used to receive data and instructions from the network 222 and to transmit data to other nodes via the network 222. The processor 228 may include one or more circuits and may be configured to execute modules, operating systems, middleware, user-level applications, other computer instructions, or any combination thereof.

In some embodiments, the processor 228 may execute an operating system 230, which may in turn act as a platform for running a set of applications 232 and an agent application 231. The types, varieties, numbers, and versions of processors, operating systems, and application sets for each node of network 222 may be different, and the specific configuration information for the nodes may be stored in the node configurations database 210. For example, the first node 224, the second node 218, and the third node 220 may have different system configurations. In some embodiments, the first node 224 and the third node 220 may have the same configuration, but the second node 218 may have a different configuration. The variety of system architectures, operating systems, applications, and configurations of the nodes may utilize different instructions to execute generic tasks. The instructions corresponding to each node configuration may be stored in the instructions database 212.

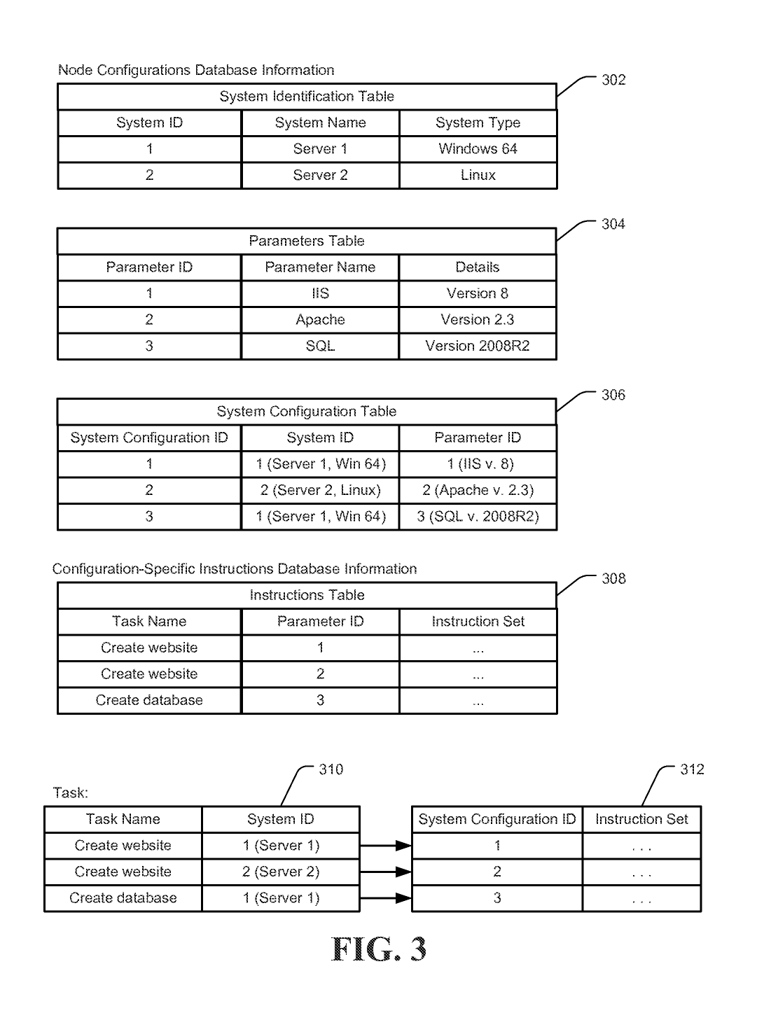

Accordingly, the system 200 may perform tasks on nodes of a network without a need for a priori knowledge of the configurations of those nodes. A generic task may be received at a translation manager 202. The translation manager 202 may access, based on the generic task, node configuration information and configuration-specific instructions stored to one or more databases. The configuration specific instructions can be applied or executed to perform the task on a selected node. Examples of data elements and data structures stored to databases of the system 200, such as stored to a node configurations database 210 and a configuration-specific instructions database 212, are depicted in FIG. 3.

FIG. 3 depicts a diagram 300 of data elements used by a system configured to select instructions based on a generic directive, in accordance with certain embodiments of the present disclosure. Diagram 300 may depict a number of generic tasks or directives 310 received by a translation manager. Diagram 300 may also depict data elements or data structures stored in one or more databases accessible by a translation manager, such as databases 210 and 212 of FIG. 2. For example, tables 302, 304, and 306 may be used to identify configurations and settings of nodes associated with a network. In some examples, a table 308 may include instruction sets for performing a variety of tasks at a node based on identified configuration settings for the node.

In an example embodiment, a node configurations database 210 may store data relating to configuration settings and configuration options for nodes in a network. For example, the node configurations database 210 may store data elements as depicted in system identification table 302. System identification table 302 may include a “system ID” field providing an identification number for nodes in the network; a “system name” field listing names for nodes in the network; and a “system type” field identifying an operating system for each node. In some embodiments, the “systems” listed may be one or more devices on which a software-based node is executing, or a primary device on which a core component of an application-based node is executing (or can be executed). In some embodiments, the “systems” listed in the system identification table may be “virtual machines”, physical machines, or a combination of both. For example, a virtual machine may be an emulated instance of a computing device, including its own configuration settings, operating system, available applications, and other settings. A single physical node or system may execute one or more virtual machines simultaneously, with each virtual machine having different settings and options. Other embodiments are also possible.

In an example embodiment of FIG. 3, system ID 1 may refer to a node having a system name “server 1”, which may be configured to run a “Windows® 64-bit” operating system as a system type. System ID 2 may refer to a node having a system name “server 2”, which may be configured to run a Linux® operating system. Other systems or nodes may also be included, each having an associated system name and system type.

The node configurations database 210 may store data elements as depicted in parameters table 304. Parameters may refer to specific details about how a system or node may be configured, and may define what capabilities the system or node has for performing different tasks or directives. Some examples of parameters may include software or computer application instances, different versions of software or firmware, system architecture, installed drivers, or other details about a node which may define what tasks the node is configured to perform. One or more entries from the parameters table may apply to any given node on a network. In some embodiments, the parameters table 304 may include a “parameter ID” field providing an identification number for a specific type of application or functionality which may be executed on a node; a “parameter name” field identifying an application or other configuration; and a “details” field which may provide additional information about a parameter, such as a software version for an application. For example, various nodes in the network may be capable of executing the same type of computer application, but different nodes may have different versions of that application, which different versions may provide different functionality and accept different instructions. In another example, some software may have different versions compatible with different operating systems, and the different versions may accept different instructions. Accordingly, the different versions of an application may each have an entry in the parameters table 304. In some embodiments, the “details” field or another field may identify or correlate specific parameters with a listing of tasks or directives that those parameters may be used to perform (e.g., identifying which applications can perform tasks such as “create website” or “create database”).

In the example embodiment of table 304, parameter ID 1 may be used to identify systems or nodes configured provide web server or database functionality using Internet Information Services (IIS) version 8. Parameter ID 2 may refer to systems or nodes configured to run or implement the Apache Cassandra database management system, version 2.3. Parameter ID 3 may refer to systems or nodes configured to run or implement the structured query language (SQL), version 2008R2, for database management. Other embodiments are also possible. A parameter ID may be used to refer to any system or node having the listed characteristics. In some embodiments, a single system may be configured to run or implement multiple parameters, such as being configured to run both IIS v. 8 and SQL v. 2008R2. Other embodiments are also possible. The parameters of a system may be used to determine what tasks a system can perform, and the appropriate instruction set to implement those tasks.

The node configurations database 210 may store data elements as depicted in system configuration table 306. System configuration table 306 may relate specific systems or nodes (as identified in system identification table 302) to specific parameters (as identified in parameters table 304). System configuration table 306 may include a “system configuration ID” field providing an identification number for a particular combination of a node in the network and a parameter or capability of the node; a “system ID” field listing the system ID for a node from system identification table 302; and a “parameter ID” field listing the parameter ID from parameters table 304. Because individual systems or nodes may be configured with multiple parameters, the same system or node may have multiple entries on the system configuration table 306.

For example, system configuration ID 1 may refer to server 1 (system ID 1), which may be configured to run or implement IIS v. 8 (parameter ID 1). System configuration ID 2 may refer to server 2 (system ID 2), which may be configured to run or implement Apache v. 2.3 (parameter ID 2). System configuration ID 3 may refer to server 1 again (system ID 1), which may also be configured to run or implement SQL v. 2008R2 (parameter ID 3). As depicted, server 1 (system ID 1) may be configured to run both IIS and SQL, and accordingly may correspond to system configuration ID 1 and to system configuration ID 3.

In some embodiments, data regarding instructions for performing generic tasks or directives may be stored in a database, such as the configuration-specific instructions database 212 of FIG. 2. For example, the instructions may be stored in the database based on a task name and parameter ID, as shown in table 308. In some embodiments, a “system configuration ID” or other identifier may be used to associate a task with a specific set of instructions. In an example embodiment, the task “create website” may be performed on systems or nodes with parameter ID 1 (e.g. running IIS v. 8) with the first set of stored instructions. The task “create website” may also be implemented or performed on systems or nodes with parameter ID 2 (e.g. running Apache v. 2.3) with the second set of stored instructions. The task “create database” may be performed or implemented on systems or nodes with parameter ID 3 (e.g. systems running SQL v. 2008R2) with the third set of stored instructions. Additional tasks or directives may also be included, as well as instructions for the listed tasks with different parameter configurations. In some embodiments, tasks may be broken down into smaller task subsets. For example, instead of the task “create website,” there may be separate subset tasks for establishing a website domain, for creating a website template, for creating e-mail or user accounts associated with the website, for customizing specific aspects of the website, for other related tasks, or any combination thereof.

In some embodiments, input data received at the translation manager 202 may specify a generic task or directive, and may specify a system on which to implement the task. Tasks table 310 depicts an example selection of generic tasks or directive. Tasks table 310 may include a “task name” field identifying the type of generic task or directive to be performed, and a “system ID” field identify a system or node on which to perform the task. A translation manager 202 may determine a set of instructions configured to direct the specified system to perform the specified task, as depicted in the execution instructions table 312. For example, execution instructions table 312 may include a “system configuration ID” field identifying a system configuration (e.g. a specific application loaded on a specific system or node), and an “instruction set” field identifying a set of instructions to execute the task on the corresponding system configuration.

In an example embodiment, the input data may specify a task to “create a website” and may designate the target system or node as system ID 1 (server 1). In some embodiments, the target system or node may be identified by system name or some other identifier. The translation manager 202 may then look up the characteristics of the designated node in a database. For example, the translation manager 202 may use system identification table 302 from node configurations database 210 to determine that system ID 1 is running a Windows® 64-bit operating system, and may then determine parameters configured to perform the task that are compatible with the determined operating system. The translation manager 202 may consult parameters table 304 to determine what parameters may be used to perform the task “create website.” In some embodiments, the translation manager 202 may consult instructions table 308 from the configuration-specific instructions database 212 to determine parameter IDs of node parameters that can be used to perform the specified task. The translation manager 202 may determine that parameter IDs 1 and 2, corresponding to parameters IIS version 8 and Apache version 2.3, respectively, can be used to perform the specified task. The translation manager 202 may then consult system configuration table 306 to determine whether system ID 1 is configured with a parameter that can be used to perform the task. The translation manager 202 may determine that system ID 1 is configured to run IIS v. 8, and may be used to create websites.

If multiple potential matches occur for executing the task (e.g. multiple parameters on the target node can perform the task), further input may be requested from the user or system that submitted the input data. For example, further input may be requested to determine which particular entry should be used to perform the designated task. In some embodiments, the translation manager 202 may automatically select an application or other parameter for executing the task, based on specific selection criteria. For example, an application may be selected based specific characteristics of the parameters. For example, the translation manager 202 may select the potential match that was most recently updated within the system or has the most recent update version. In some embodiments, a selected parameter may be designated as the default application for performing a particular task. In some embodiments, the translation manager 202 may access a priority list designating an order in which to select applications, for example if selected applications are busy or not currently operational. Other embodiments are also possible.

For each selected parameter or entry, the translation manager 202 may access the instructions table 308 from the configuration-specific instructions database 212 to retrieve the appropriate instruction set for performing the designated task on the selected parameter. The translation manager 202 may generate and output a list of instructions for the designated system or node, which list may be provided to a user device that provided the input data, to the target node, or to another system or element.

There may be many variations of the steps performed by the translation manager 202, or to the types and structure of the data stored to databases 210 and 212. For example, the translation manager 202 may receive input data indicating the task “create website” and a system ID 1. The translation manager 202 may determine what parameters may be used to perform the designated task and the corresponding parameter IDs, such as by consulting parameters table 304 or instructions table 308. For example, the translation manager 202 may determine that the task “create website” can be performed by parameter IDs 1 and 2 (e.g. corresponding to IIS v. 8 or Apache v. 2.3). The translation manager 202 may then determine systems or nodes having the eligible parameters, such as by consulting system configuration table 306. For example, the translation manager 202 may determine that nodes corresponding to both system ID 1 and system ID 2 include an eligible parameter. Because system ID 1 is among the determined systems, the translation manager 202 may retrieve instructions from table 308 corresponding to the determined parameter ID 1 and the designated task “create website.”

In another example embodiment, the input data may simply designate a task, such as “create website,” without designating a system on which to implement the task. The translation manager 202 may consult parameter table 304 or instructions table 308 to determine which parameters may be used for performing the “create website” task, such as IIS v. 8 or Apache v. 2.3. The translation manager 202 may then consult system configuration table 306 to determine that the eligible parameters are available on server 1 and server 2. In some embodiments, the translation manager 202 may select a default node from server 1 or server 2, for example based on which node is listed first in the database. Translation manager 202 may choose the node based on other factors, such as selecting the node having the lowest workload, the fastest response time, some other metric, or any combination thereof. In some embodiments, the translation manager 202 may present the potential node options to a user for selection. Other embodiments are also possible. Once the target node and corresponding system configuration ID are selected, the translation manager 202 may retrieve the instruction set from table 308.

In some embodiments, input data may designate a task and a target system or node. The translation manager 202 may determine that the designated node has more than one method of performing the task (e.g., the node includes both IIS v. 8 and Apache v. 2.3). The translation manager 202 may request additional information from a user or system that provided the input data, such as requesting a designation of which method to use to perform the task. The translation manager may then retrieve the appropriate instructions based on the response to the request for additional information.

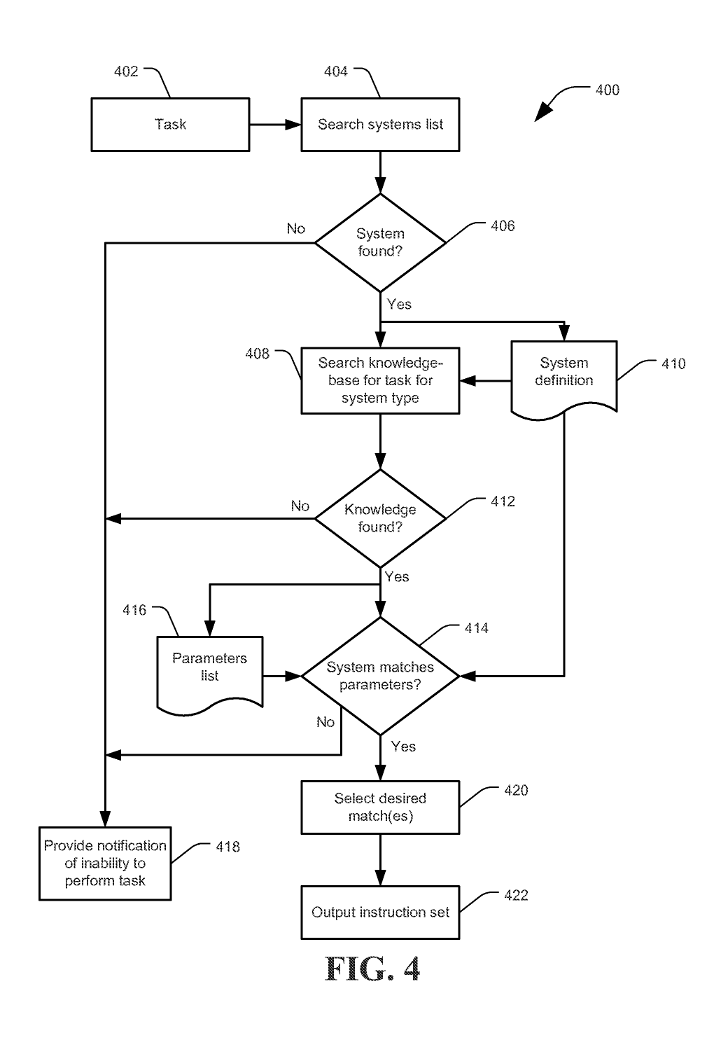

As discussed, there may be a number of variations of steps and methods for determining an instruction set based on a generic directive. An example embodiment of such a method of instruction selection is described below with respect to FIG. 4.

FIG. 4 depicts an example flowchart of a method 400 of instruction selection based on a generic directive, in accordance with certain embodiments of the present disclosure. In some embodiments, method 400 may be performed by a translation manager, such as translation manager 202 depicted in FIG. 2.

The method 400 may include receiving a generic task or directive, at 402. For example, the generic task or directive may be data identifying a task or directive to be performed, and in some embodiments may also include an indication of a target computing node or system by which the task should be performed. The indication of the computing node may identify a target node based on one or more specified characteristics of the computing node. For example, the characteristics identified by the indication may include a system ID or other specific node identifier, a type of computing device (e.g. a content server), a type of application (e.g. a database management application), a specific application (e.g. Apache database management application version 2.3), a type of service (e.g., a web server node), an operating system of the node, other characteristics, or any combination thereof. In some embodiments, a user may specify a generic task, and may designate, explicitly or implicitly, that the task is to be performed by the user's own device. For example, a user may select a task to perform using a user interface (UI) application. Some tasks may only be performed by the user's device, or may default to the user's device if another node is not selected. The UI application may automatically designate the user device as the target node in the absence of a specific node designation from the user. Other embodiments are also possible.

The method 400 may include searching a system list, at 404. In some embodiments, the system list may be stored in a database and include data regarding nodes or other systems included in a network managed by the translation manager 202. For example, if the task received at 402 identifies a target system or node, the method 400 may include verifying that the designated target node is recognized as part of the network or overall system. In some embodiments, the method 400 may also include retrieving information about the target node, such as an operating system running on the node. In some embodiments, the information may be retrieved by requesting information from an agent application running on the node. The method 400 may include determining if a matching system was found, at 406. If the system is not found or if the agent application does not respond, at 406, the method 400 may include, at 418, returning a notification of the inability to perform the task in response to the received task from 402. For example, an error notification may be provided to a user device, or a failure notification may be returned to a requesting node or system.

If the system is found, at 406, the method 400 may optionally involve retrieving a system definition (e.g. configuration data or other data about the target node), at 410. For example, the system definition may not be retrieved at 410 if the system definition or other configuration data was retrieved at 404. In some embodiments, system definition data may be retrieved later, or may not need to be retrieved at all. In some embodiments, the system definition may include a “system type” for the target system or node (e.g., an operating system, a classification for the node such as “edge server” or “content server, other information, or any combination thereof). In some embodiments, the system definition may further include parameter information about the node, such as specific software applications installed at the node.

At 408, the translation manager 202 may search a knowledgebase to determine whether the specified task can be performed by nodes having the system type of the target node. For example, the translation manager may search a database to determine whether there are any parameters (e.g. applications or processes) operable with the target node's operating system, and for which instructions are available to perform the designated task. In some embodiments, the translation manager 202 may retrieve a list of known applications or processes which can be used to perform the task, and may not determine whether those processes are configured to operate with the system type of the target node. In some embodiments, the translation manager 202 may determine if at least one instruction set is stored in a database for performing the specified task, and if so, may determine with what applications or processes the instruction set may be implemented. Other embodiments are also possible. If no instructions or applications corresponding to a target node are found in the knowledgebase for performing the task, the method 400 may include providing a notification of the inability to perform the task, at 418.

In some embodiments, the method 400 may also include searching the knowledge base for supplementary information for a set of instructions, for a particular task, for one or more system configurations, for other information, at 408. For example, supplementary information may include information relating to the duration or resource needs of instruction sets. Retrieved supplementary information may be presented to a user, to a node which initiated the task request at 402, to another device or node, or any combination thereof. For example, the supplementary information may be used to determine if there is sufficient resources or time available to perform the operation for planning or logistics purposes. Furthermore if multiple instruction sets are available, as described below at 420, the supplementary information may be used in determining which instruction set to select. The supplementary information may be retrieved and provided at 408, or may be retrieved and provided at a later point, such as at 414 or 420 below.

If the knowledge for performing the designated task on the system is found, at 412, the method 400 may optionally include retrieving an applications list including the specific applications or processes available from the target system (e.g., system parameters), at 416. In some embodiments, a separate parameters list may not need to be retrieved if a database including the eligible applications also includes references to which systems include those applications.

The method 400 may then include determining, at 414, whether any of the applications available at the target node correspond to the applications for which instructions are available for performing the task, as determined at 408. For example, instructions may be available to perform the task “create website” with an IIS application running on a Windows® operating system. The designated target system may include a Windows® operating system, but may not include an instance of the IIS application, and may therefore not be configured to perform the task. If the target node or system does not have any of the applications or processes for performing the task, at 414, the method 400 may include providing a notification of the inability to perform the task at the target node, at 418. In some embodiments, supplementary information for any matching compatible instruction sets, applications, or other system configurations, as described above in relation to 408, may be retrieved and provided to a requesting node at 414.

If the target node or system does include at least one of the matching applications or processes for the task, at 414, the method 400 may optionally include selecting one of the matching applications, at 420. For example, if multiple options are available at the target node for performing the task, a user device or requesting system may be queried to select which option to use. In some embodiments, supplementary information may be provided to assist in selecting an application, such as an estimated time or resource consumption for completing the task on each available application. In another embodiment, the translation manager may select which option to employ based on a variety of factors (e.g. a preferred order of applications for performing the specified task, whether one of the options is busy performing other tasks, based on retrieved supplementary data, or based on other information or factors). Once an application or process is selected to perform the task on the target node, the method 400 may include retrieving the corresponding instructions for performing the specified task on the selected application or process, and outputting the instruction set, at 422. For example, the instruction set may be provided to a user device or to a system that provided the task at 402. In some embodiments, the instructions may be sent directly to the target system for execution. In some embodiments, the instruction set may be provided to an execution management module for controlling the execution of the task by the target node. Other embodiments are also possible.

The illustrations, examples, and embodiments described herein are intended to provide a general understanding of the structure of various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. For example, in the flow diagrams presented herein, in certain embodiments blocks may be removed or combined without departing from the scope of the disclosure. Further, structural and functional elements within the diagram may be combined, in certain embodiments, without departing from the scope of the disclosure. For example, certain modules and components may be combined, or split into sub-components. Functionality assigned to a particular component or module may be handled by another component instead. Moreover, although specific embodiments have been illustrated and described herein, it should be appreciated that any subsequent arrangement designed to achieve the same or similar purpose may be substituted for the specific embodiments shown.

This disclosure is intended to cover any and all subsequent adaptations or variations of various embodiments. Combinations of the above examples, and other embodiments not specifically described herein, will be apparent to those of skill in the art upon reviewing the description. Additionally, the illustrations are merely representational and may not be drawn to scale. Certain proportions within the illustrations may be exaggerated, while other proportions may be reduced. Accordingly, the disclosure and the figures are to be regarded as illustrative and not restrictive.

What is claimed is:

1. A memory device including instructions that, when executed, cause a processor to:
receive a request to perform a designated task;
determine a computing node to perform the designated task;
determine a specific instruction set to perform the designated task based on one or more characteristics associated with the computing node; and
provide the specific instruction set to the computing node in response to the request.

2. The memory device of claim 1, wherein the request includes an indication of the computing node to perform the designated task.

3. The memory device of claim 2, wherein the indication identifies the computing node as a selected type of computing device or as a type of service executed by one or more computing devices.

4. The memory device of claim 2 further including instructions that, when executed, cause a processor to:
determine a list of applications configured to perform the designated task;
determine whether the computing node includes an application from the list of applications; and
retrieve the specific instruction set corresponding to the application from the list of applications when the computing node includes the application.

5. The memory device of claim 2 further including instructions that, when executed, cause a processor to:
determine an operating system associated with the computing node; and
retrieve the specific instruction set from an instructions database when the instructions database includes the specific instruction set for performing the designated task on an application compatible with the operating system.

6. The memory device of claim 5 further including instructions that, when executed, cause a processor to:
determine whether the instructions database includes multiple specific instruction sets corresponding to multiple applications compatible with the operating system for performing the designated task; and
automatically select one or more of the multiple applications based on a characteristic of the selected one or more applications when multiple specific instruction sets are included in the instructions database.

7. The memory device of claim 5 further including instructions that, when executed, cause a processor to:
determine whether the instructions database includes multiple specific instruction sets corresponding to multiple applications compatible with the operating system for performing the designated task; and
request a user selection of one or more of the multiple applications when multiple specific instruction sets are included in the instructions database.

8. The memory device of claim 7 further including instructions that, when executed, cause a processor to retrieve specific instruction sets corresponding to the selected one or more of the multiple applications based on the user selection.

9. The memory device of claim 1 further including instructions that, when executed, cause a processor to:
determine the computing node, including:
access a node configurations database including information regarding configurations for multiple computing nodes in a network,
select the computing node to perform the designated task from the multiple computing nodes;
determine the specific instruction set, including:
access a configuration-specific instructions database including instructions for performing a selection of tasks on different computing node configurations; and
retrieve the specific instruction set from the configuration-specific instructions database based on configuration information for the computing node retrieved from the node configurations database.

10. The memory device of claim 1 further including instructions that, when executed, cause a processor to select the computing node from multiple computing nodes in a network based on a determination of which computing node is configured to perform the designated task.

11. A method comprising:
receiving a request to perform a designated task;
determining a selected application configured to perform the designated task;
determining a computing node having an instance of the selected application;
determining a specific instruction set to perform the designated task on the selected application; and
providing the specific instruction set to computing node in response to the request.

12. The method of claim 11, wherein the request includes an indication of the computing node to perform the designated task.

13. The method of claim 12, wherein the indication identifies the computing node based on specified characteristics of the computing node.

14. The method of claim 12 further comprising:
determining a list of applications configured to perform the designated task;
determining whether the computing node includes an application from the list of applications; and
selecting the selected application from applications of the computing device included on the list of applications.

15. The method of claim 12 further comprising:
determining an operating system of the computing node;
determining whether an instructions database includes the specific instruction set for performing the designated task on an eligible application compatible with the operating system;
determining whether the computing node includes the eligible application;
determining the selected application to be the eligible application when the computing node does include the eligible application; and
retrieving the specific instruction set from the instructions database when the instructions database includes the specific instruction set for the selected application.

16. The method of claim 15, further comprising:
determining whether the instructions database includes multiple specific instruction sets corresponding to multiple eligible applications for performing the designated task; and
requesting a user selection of one or more of the multiple eligible applications when multiple specific instruction sets are included in the instructions database.

17. The method of claim 15, further comprising:
determining whether the instructions database includes multiple specific instruction sets corresponding to multiple eligible applications for performing the designated task; and
automatically selecting one or more of the multiple eligible applications based on specific selection criteria.

18. The method of claim 11, further comprising:
determining the computing node, including:
accessing a node configurations database including information regarding configurations for multiple computing nodes in a network,
selecting the computing node to perform the designated task from the multiple computing nodes;
determining the specific instruction set, including:
accessing a configuration-specific instructions database including instructions for performing a selection of tasks on different computing node configurations; and
retrieving the specific instruction set from the configuration-specific instructions database based on configuration information for the computing node retrieved from the node configurations database.

19. The method of claim 11, further comprising selecting the computing node from multiple computing nodes in a network based on a determination of which computing node is configured to perform the designated task.

20. A system comprising:
a processor configured to:
receive a request to perform a designated task;
determine a computing node to perform the designated task;
determine a specific instruction set to perform the designated task based on the computing node; and
provide the specific instruction set in response to the request.

21. The system of claim 20, further comprising:
a node configurations database including information regarding configurations for multiple computing nodes in a network, the computing node to perform the designated task selected from the multiple computing nodes;
a configuration-specific instructions database including instructions for performing a selection of tasks on different computing node configurations; and
the processor configured to determine the specific instruction set, including retrieving the specific instruction set from the configuration-specific instructions database based on configuration information for the computing node retrieved from the node configurations database.

22. The system of claim 20, the processor further configured to:
determine an identifier for the computing node based on specific parameters of the computing node;
determine whether an instructions database includes the specific instruction set for performing the designated task on a device having the determined identifier; and
retrieve the specific instruction set from the instructions database when the instructions database includes the specific instruction set for the determined identifier.

23. The system of claim 22, the processor further configured to:
determine a plurality of identifiers for the computing node based on a plurality of applications of the computing;
determine whether the instructions database includes multiple specific instruction sets for performing the designated task corresponding to the plurality of applications; and
request a user selection of one or more of the plurality of applications when multiple specific instruction sets are included in the instructions database.

24. The system of claim 20, wherein:
the request includes an indication of the computing node to perform the designated task;
the processor further configured to:
determine an operating system of the computing node;
determine whether an instructions database includes the specific instruction set for performing the designated task on an application compatible with the operating system;
determine whether the computing node includes the application; and
retrieve the specific instruction set from the instructions database when the instructions database includes the specific instruction set for the application and the computing node includes the application.
